(19) United States
(12) Patent Application Publication
(10) Pub. No.: US 2012/0059969 A1
(43) Pub. Date: Mar. 8, 2012

(54) NON-INVASIVE DIRECT-MAPPING USB SWITCHING DEVICE

(75) Inventors: CHENG-SHENG CHOU, Banciao City (TW); Chien-Fa Lin, Banciao City (TW)

(73) Assignee: June-On Technology Co., LTD., Banciao City (TW)

(21) Appl. No.: 12/906,130

(22) Filed: Oct. 17, 2010

(30) Foreign Application Priority Data
Sep. 3, 2010 (TW) 099129802

(51) Int. Cl. G06F 13/00

(52) U.S. Cl. 710/316

(57) ABSTRACT

A non-invasive direct-mapping USB switching device includes a main-controlled microprocessing module connected to a high-impedance module, and the high-impedance module is provided for detecting and monitoring a functional instruction code of a USB device transmitted from a data transmission module, such that a USB connecting module can be used for transmitting the USB data and functional instruction code to detect and monitor the data transmission module when the USB device is connected to the USB switching device. If the data transmitted from the data transmission module is not the required functional code, the non-required functional code (such as the USB data) will be passed, so that the USB device can be connected and communicated with a plurality of computer devices through another USB connecting module and a switching module to achieve a plug-and-play function.

### BACKGROUND OF THE INVENTION

1. Field of the Invention

The present invention relates to a non-invasive direct-mapping USB (universal serial bus) switching device, and more particularly to a USB switching device having a high-impedance module provided for detecting and monitoring a functional instruction code for a switch (or a switch control command) of a data transmission module and allowing normal data of a USB device to pass through, such that the USB device can be connected and communicated with a plurality of computer devices to achieve a plug-and-play function.

2. Description of Related Art

When a conventional USB switching device is connected to two sets of computers, an external USB device (such as an external USB keyboard or an external USB mouse), the external USB device is controlled by a main-controlled microprocessor or a microcontroller (MCU) installed in the USB switching device, and the operation of the external USB device is simulated by a simulation program stored in a build-in or external memory, so that the external USB device will be replaced by the simulation program preinstalled in the main-controlled microprocessor. If the original external USB device is changed and connected to the conventional USB switching device, and the changed external USB device includes a new add-on function (such as a multimedia control, a short-cut key setup or a hot key setup), users will be unable to use the new add-on function of the updated external USB device since the simulation program cannot simulate the new add-on function of the updated external USB device. In other words, the conventional USB switching device fails to connect, operate, and communicate with the updated external USB device, such that all operating functions of the updated external USB device are totally lost and the requirement for a user's operation cannot be satisfied.

Besides the simulation program used for simulating the operation of the external USB device, the conventional USB switching device further adopts an intercepting method to determine the operation of the external USB device, and the main-controlled microprocessor communicates with the external USB device through a default program installed in the built-in or external memory to enable the external USB device and transfer the device data to computers. In other words, the main-controlled microprocessor in the conventional USB switching device reads and determines the externally connected USB device by the default program. However, the reading and determination cannot be done by the original program of the updated external USB device (which means that the updated external USB device cannot be interpreted by the program anymore, and the conventional USB switching device can no longer communicate with the external computer anymore). If the external USB device is determined to be readable and interpretable by the program in the determination, then the external USB device will be allowed to communicate with the external computer, and a delay time will be required to switch to another external computer for bidirectional communications with the other external computer.

Regardless of using the simulation program to simulate the operation of the external USB device or using the intercepting method to determine the operation of the external USB device, if the external USB device is updated with a new add-on function, then the simulation program or default program stored in the built-in or external memory of the conventional USB switching device must be coded again, so that the simulation program or the default program installed in the built-in or external memory can be updated to allow the updated external USB device to connect and communicate with the external computer through the conventional USB switching device. Coding the simulation program or the default program by programmers not only takes time and efforts, but also incurs a risk of having an incomplete program or occupying much memory space by the newly coded simulation program or default program and resulting in an insufficient memory capacity of the built-in or external memory available for storage. Therefore, the new add-on function of the updated external USB device cannot be enabled, or the external USB device of a different model cannot be connected and communicated with the external computer. The aforementioned drawback causes tremendous inconvenience to users.

If the conventional USB switching device is connected to the external USB device and several sets of external computers, the conventional USB switching device will perform a simulation or intercept to the external USB device. As long as the external USB device is updated or a new add-on function is added to the external device, the external USB device will fail to connect and communicate with the external computers through the conventional USB switching device. Obviously, the aforementioned drawback of the prior art demands immediate attentions and feasible solutions.

### SUMMARY OF THE INVENTION

Therefore, it is a primary objective of the present invention to provide a non-invasive direct-mapping USB switching device including a main controlled microprocessing module installed in the USB switching device and connected to a high-impedance module, and the high-impedance module is provided for detecting and monitoring a functional instruction code of a switch (or a switch control command) of a data transmission module installed on a USB device, such that if the detected data in the USB data line (D+ and D−) are normal USB device data but not the switch control command, then these USB data will be allowed to pass through, and the USB device will be able to connect and communicate with one of the computer devices to achieve a plug-and-play function.

To achieve the aforementioned objective, the present invention adopts the following technical measure and provides a non-invasive direct-mapping USB switching device comprising: a first USB connecting module, for connecting a USB device, and transmitting all USB data of the USB device and functional instruction code of the switch; a data transmission module, for receiving and transmitting the all USB data; a second USB connecting module, for connecting and transmitting the all USB data; a switching module, for receiving and transmitting the USB device data; a high-impedance module, electrically connected in parallel with the data transmission module, for detecting and determining whether or not data transmitted from the data transmission module constitute a required functional instruction code; and a main controlled microprocessing module, electrically connected to the high-impedance module, for receiving and determining whether or not data transmitted from the high-impedance module constitute a required functional instruction code, and driving the switching module to perform a switching operation according to the functional instruction code.

### BRIEF DESCRIPTION OF THE DRAWINGS

The invention, as well as its many advantages, may be further understood by the following detailed description and drawings in which:

FIG. 1 is a schematic circuit block diagram of a non-invasive direct-mapping USB switching device in accordance with a first preferred embodiment of the present invention;

FIG. 2 is another schematic circuit block diagram of a non-invasive direct-mapping USB switching device in accordance with a first preferred embodiment of the present invention;

FIG. 3a is a schematic circuit block diagram of a USB microcomputer module in accordance with the present invention;

FIG. 3b is a schematic circuit block diagram of another USB microcomputer module in accordance with the present invention;

FIG. 4 is a schematic circuit block diagram of a non-invasive direct-mapping USB switching device in accordance with a second preferred embodiment of the present invention;

FIG. 5 is a schematic circuit block diagram of a non-invasive direct-mapping USB switching device in accordance with a third preferred embodiment of the present invention; and

FIG. 6 is a schematic circuit block diagram of a non-invasive direct-mapping USB switching device in accordance with a fourth preferred embodiment of the present invention.

### DETAILED DESCRIPTION OF THE INVENTION

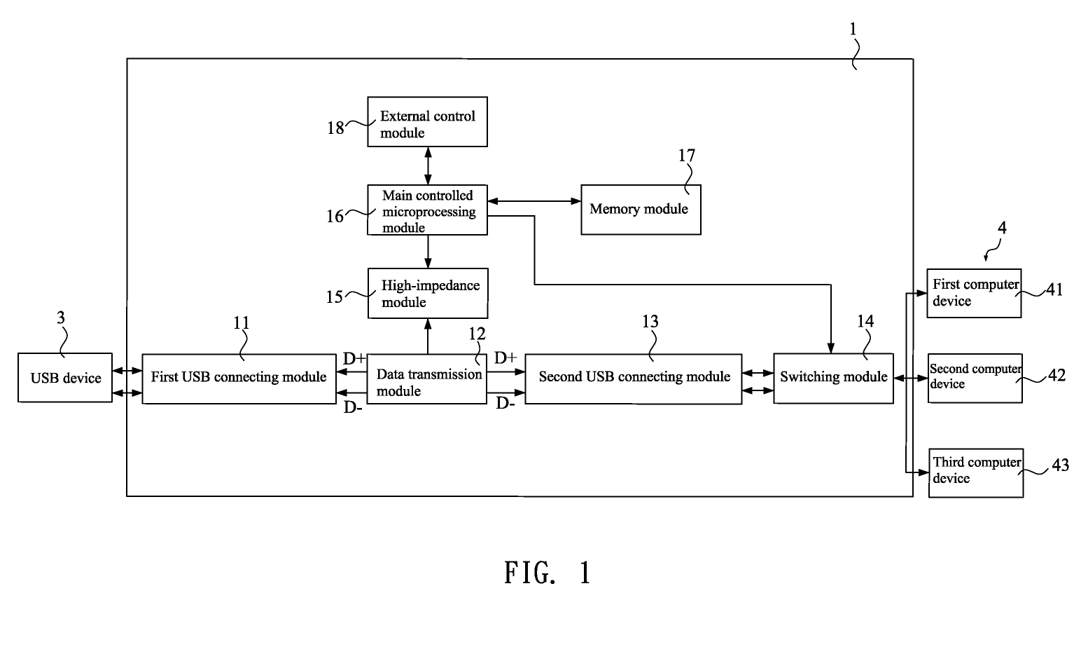

With reference to FIGS. 1 to 3b for a non-invasive direct-mapping USB switching device in accordance with a first preferred embodiment of the present invention, the non-invasive direct-mapping USB switching device 1 comprises a first USB connecting module 11, a data transmission module 12, a second USB connecting module 13, a switching module 14, a high-impedance module 15, and a main controlled microprocessing module 16.

The first USB connecting module 11 is provided for connecting a USB device 3 and transmitting the device data of the USB device and the functional instruction code for a switch.

The data transmission module 12 is provided for receiving and transmitting all USB data and functional instruction codes.

The second USB connecting module 13 is provided for connecting a computer and transferring USB device data to computers.

The switching module 14 is provided for selecting a function to switch a USB data bus to a selected computer and avoid the functional instruction code for a switch to be transferred to computers.

The high-impedance module 15 is electrically connected in parallel with the data transmission module 12 for detecting and determining whether or not data transmitted from the data transmission module 12 constitute a required functional instruction code.

The main controlled microprocessing module 16 is electrically connected to the high-impedance module 15 for receiving and determining whether or not data transmitted from the high-impedance module constitute a required functional instruction code, and driving the switching module to perform a switching operation according to the functional instruction code.

When the USB switching device 1 is connected to the USB device 3 through the USB connecting module 11, and the switching module 14 is connected to a plurality of computer devices 4, the main controlled microprocessing module 16 is electrically connected in parallel with the data transmission module 12 through the high-impedance module 15 for detecting a functional instruction code of the USB device 3 installed on the data transmission module 12. In other words, the high-impedance module 15 will detect the functional instruction code transmitted by a positive-phase data line D+ and a negative-phase data line D of the data transmission module 12 to determine whether or not the detected functional instruction code is the same as another functional instruction code of a default program stored in a memory module 17. If the functional instruction codes are the same, then the main controlled microprocessing module 16 will drive the switching module 14 to turn off the USB bus and perform a switching operation and switch a first computer device 41 among the computer devices 4 to a second computer device 42 or a third computer device 43 among the computer devices 4, such that the USB device 3 can be connected and communicated with the second computer device 42 or the third computer device 43. If the functional instruction codes are not the same, then the main controlled microprocessing module 16 will allow the USB data to pass through and maintain the connection and communication with the first computer device 41 among the computer devices 4.

The high-impedance module 15 in the USB switching device 1 is provided for detecting and monitoring the data transmission module 12, and the detection will not affect the data transmission module 12 from transmitting the USB data and functional instruction code, so that the USB device 3 can be connected directly to the computer devices 4 for the communication and transmission. Even if the USB device 3 is updated with a new add-on function (such as a multimedia control, a short-cut key setup or a hot key setup), or a different model of the USB device 3 is used, the USB switching device 1 still remains connected to the computer devices 4 directly without a limitation of compatibility or a problem of data transmission.

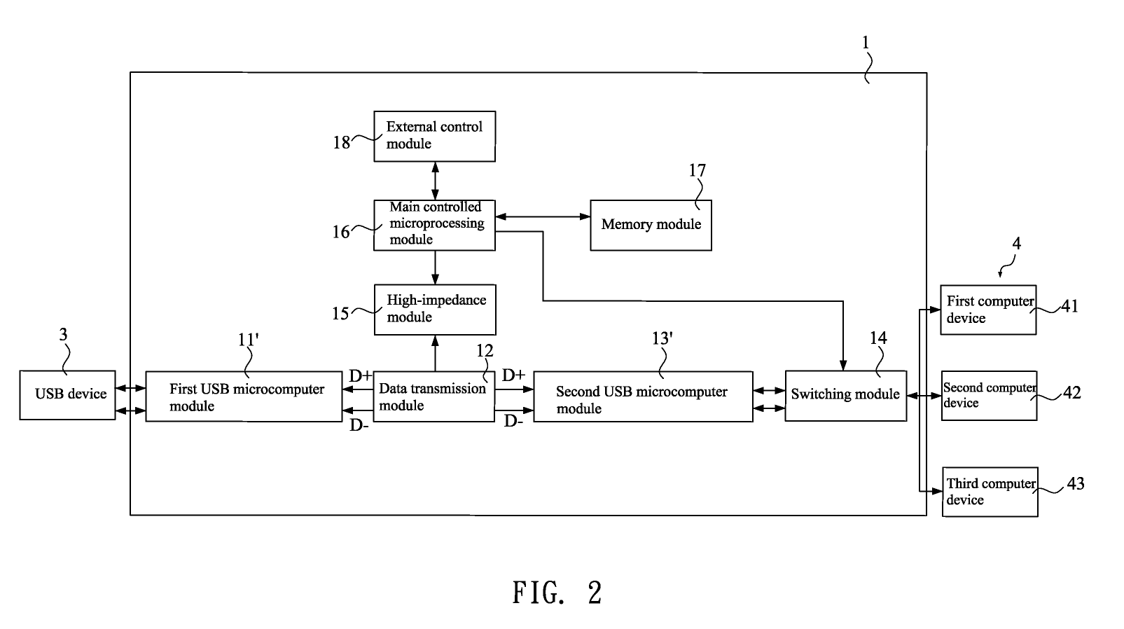

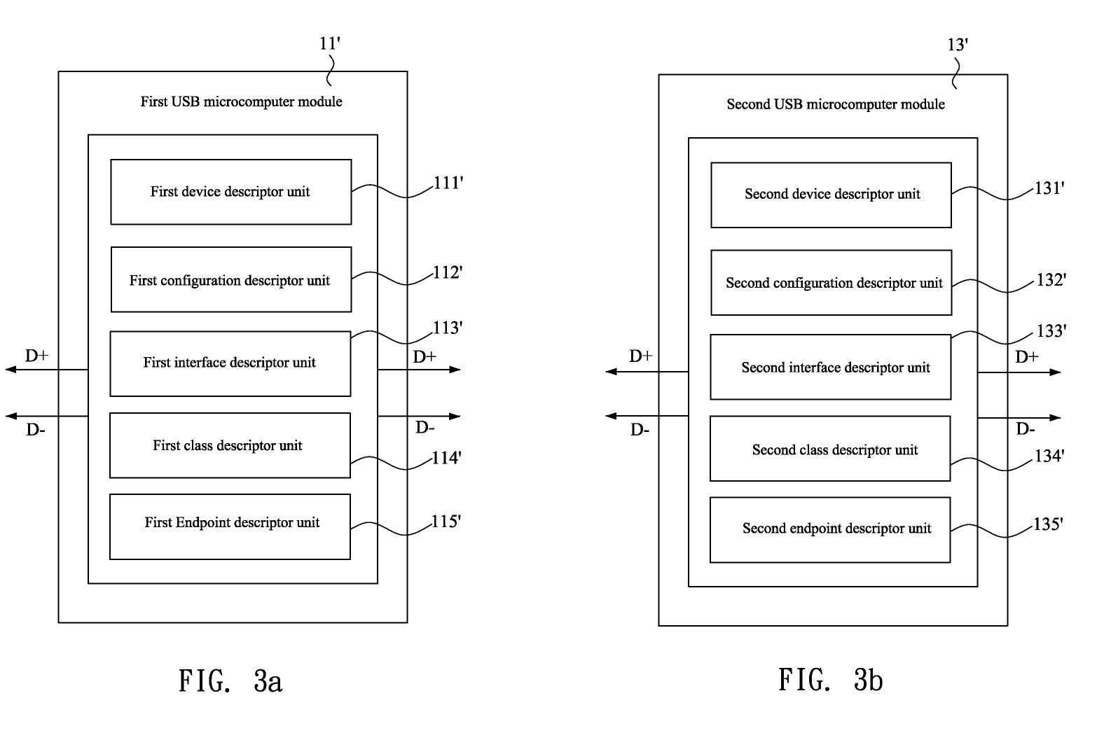

In addition, the first USB connecting module 11 and the second USB connecting module 13 can be used to substitute a first USB microcomputer module 11′ and a second USB microcomputer module 13′ (as shown in FIG. 2), and the first USB microcomputer module 11′ and the second USB microcomputer module 13′ will record USB enumeration sequences and data communicated with the USB device 3 and the computer devices 4 into the memory module 17 one by one. In other words, the USB device 3 and the computer devices 4 will communicate with a device description unit 111′, a second device description unit 131′, a first configuration descriptor unit 112′, a second configuration descriptor unit 132′, a first interface descriptor unit 113′, a second interface descriptor unit 133′, a first class descriptor unit 114′, a second class descriptor unit 134′, a first endpoint descriptor unit 115′ and a second endpoint descriptor unit 135′ in the first USB microcomputer module 11′ and the second USB connecting module 13′ respectively (as shown in FIGS. 3a and 3b), and the communicated data are stored in the memory module 17 sequentially.

If the detection conducted by units installed in the first USB microcomputer module 11′ and the second USB microcomputer module 13′ indicates an update of the USB device 3, a change of model of the USB device 3 or an addition of a new add-on function to the USB device 3, then the first USB microcomputer module 11′ and the second USB microcomputer module 13′ will record and store all descriptors and reports of the USB device 3 again, so that the computer devices 4 will request an enumeration and a connection again, and such enumeration and connection belong to dynamic device mapping. If there is no update of the USB device 3 (such as no change of model of the USB device 3, or no add-on function added to the USB device 3) during a plug-and-play process, the computer devices 4, the first USB microcomputer module 11′ and the second USB microcomputer module 13′ will remain connected, and there is no need to perform the complicated disconnecting and reconnecting operations again, and the operation of maintaining the connected status belongs to device direct mapping and allows the USB switching device 1 to achieve the plug-and-play function.

The USB switching device 1 further comprises an external control module 18 connected to the main controlled microprocessing module 16 for receiving an external control signal.

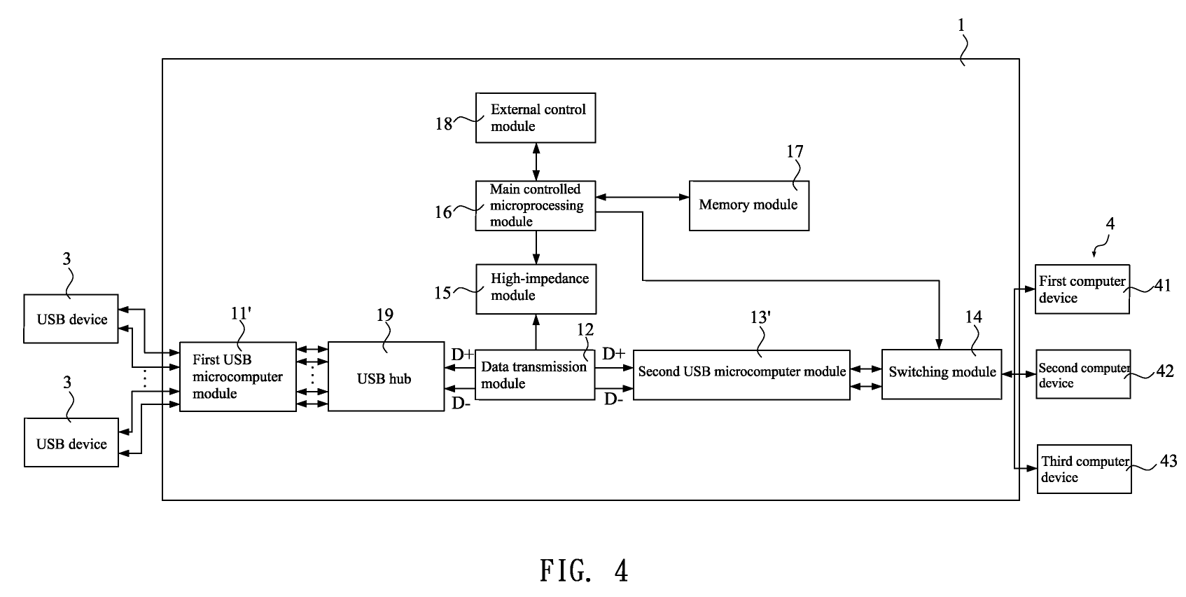

With reference to FIG. 4 for a non-invasive direct-mapping USB switching device in accordance with a second preferred embodiment of the present invention, the non-invasive direct-mapping USB switching device 1 comprises a USB hub module 19 connected between the USB connecting module 11 and the data transmission module 12, When the USB connecting module 11 is connected to a plurality of USB devices 3, an upstream data line of the USB hub module 19 can be connected to the computer devices 4 through the second USB connecting module 13 and the switching module 14 without being affected by the main controlled microprocessing module 16, and the process of setting addresses for all connected USB devices 3 is completed by the USB hub module 19 and the computer devices 4, and thus the data transmission of the USB device 3 totally depends on an address set by the USB hub module 19 and the computer devices 4, and the main controlled microprocessing module 16 can perform communications and transmissions of data with the USB hub module 19 and the computer devices 4 through the high-impedance module 15 without affecting the upstream data line of the USB hub module 19. The invention adopts a non-invasion method for the detection and monitoring and obtains the functional instruction code for controlling the USB device 3 to carry out a function specified by the functional instruction code. The remaining modules are the same as the first preferred embodiment, and thus will not be described here again.

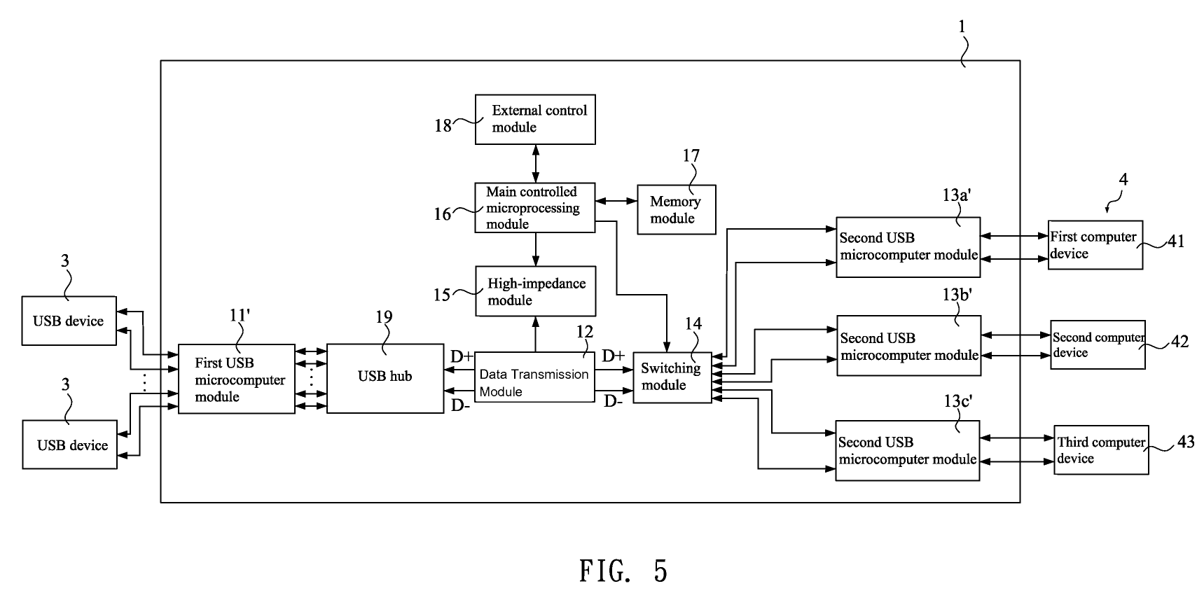

With reference to FIG. 5 for a non-invasive direct-mapping USB switching device in accordance with a third preferred embodiment of the present invention, the data transmission module 12 of the non-invasive direct-mapping USB switching device is connected to the switching module 14 directly, and the switching module 14 is connected to a plurality of second USB connecting modules 13a′, 13b′, 13c′, and the second USB connecting modules 13a′, 13b′, 13c′ are connected to the computer devices 4 respectively, such that the second USB connecting modules 13a′, 13b′, 13c′ record a plurality of USB enumeration sequences and data communicated by the USB devices 3 and the computer devices 4, so that the second USB connecting modules 13a′, 13b′, 13c′ have the dynamic device mapping and device direct mapping effects and allow the USB device 3 to be switched and connected to one of the computer devices 4 immediately without requiring any initialization for the connection and communication, so as to save the time for the communication and analysis and achieve the plug-and-play function.

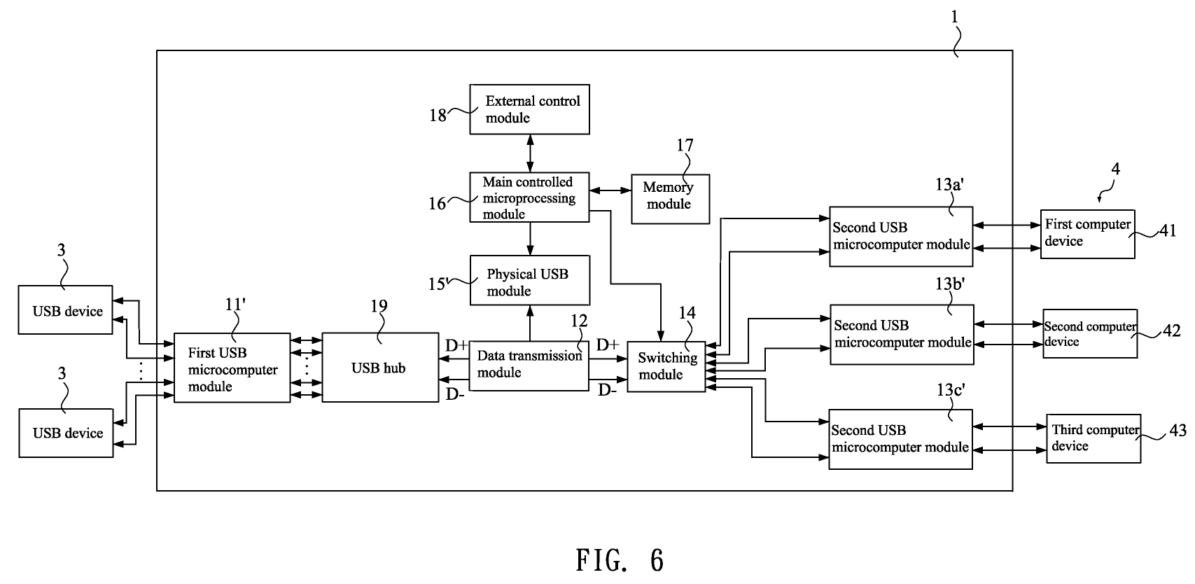

With reference to FIG. 6 for a non-invasive direct-mapping USB switching device 1 in accordance with a fourth preferred embodiment of the present invention, the high-impedance module 15 is substituted by a physical USB module (PHY) 15′, and the physical USB module (PHY) 15′ includes a USB interface program installed therein, so that the main controlled microprocessing module 16 can detect whether or not the functional instruction code in the data transmission module 12 is a required functional instruction code through the physical USB module (PHY) 15′. If the detected USB data of the USB bus is a non-required functional instruction code, then the USB data will be passed through, so that the USB device 3 can be connected and communicated with one of the computer devices 4, so as to save the time of processing related USB signals for the USB switching device 1 and achieve the plug-and-play function.

In summation of the description above, the USB switching device 1 uses the high-impedance module 15 to detect and monitor a functional instruction code of the USB device 3 installed on the data transmission module 12, such that if the USB device 3 and the USB switching device 1 are connected, the USB connecting module 11 will be used for connecting USB devices and transmitting the functional instruction code, and the high-impedance module 15 will detect and monitor the functional instruction code whenever the functional instruction code is passed through the data transmission module 12. If the detected USB data is a non-required functional instruction code, then the USB data will be passed through, so that the USB device 3 can be connected and communicated with one of the computer devices 4 to achieve the plug-and-play function.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A non-invasive direct-mapping USB (Universal Serial Bus) switching device, comprising:
a first USB connecting module, for connecting a USB device, and transmitting a USB data and a functional instruction code of the USB device;
a data transmission module, for receiving and transmitting the USB data and functional instruction code; a second USB connecting module, for connecting and transmitting the USB data and functional instruction code;
a switching module, for switching a function of a USB data line, and connecting the USB device to a selected computer;
a high-impedance module, electrically connected in parallel with the data transmission module, for detecting and determining whether or not data transmitted from the data transmission module constitute a required functional instruction code; and
a main controlled microprocessing module, electrically connected to the high-impedance module, for receiving and determining data transmitted from the high-impedance module is a required functional instruction code, and driving the switching module to perform a switching operation according to the functional instruction code.

2. The USB switching device of claim 1, wherein if the USB data is not a required functional instruction code, the switching module communicates with the connected computer device directly to pass the USB device data.

3. The USB switching device of claim 1, wherein if the functional instruction code is a required functional instruction code, the main controlled microprocessing module drives the switching module to switch to connect a computer device corresponding to the functional instruction code.

4. The USB switching device of claim 1, wherein the data transmission module includes a positive-phase data line D+ and a negative-phase data line D− for passing the USB data and functional instruction code.

5. The USB switching device of claim 1, wherein the first USB connecting module and the second USB connecting module can be substituted by a first USB microcomputer module and a second USB microcomputer module.

6. The USB switching device of claim 1, further comprising an external control module connected to the main controlled microprocessing module for receiving an external control signal.

7. The USB switching device of claim 1, further comprising a USB hub module connected between the USB connecting module and the data transmission module.

8. The USB switching device of claim 1, wherein the high-impedance module is substituted by a physical USB module.
